(19) United States
(12) Patent Application Publication
(10) Pub. No.: US 2006/0262200 A1
(43) Pub. Date: Nov. 23, 2006

(54) Video signal processing circuit

(76) Inventor: Akinobu Kondou, Kyoto (JP)

Correspondence Address: MCDERMOTT WILL & EMERY LLP, 600 13TH STREET, N.W., WASHINGTON, DC, 20005-3096, US

(21) Appl. No.: 11/435,100

(22) Filed: May 17, 2006

(30) Foreign Application Priority Data
May 17, 2005 (JP) 2005-143654

(51) Int. Cl. H04N 5/76

(52) U.S. Cl. 348/231.99

(57) ABSTRACT

A video signal processing circuit for processing a video signal inputted from an image sensor capable of reading pixels by means of pixel-thinning read or pixel-mixing read in addition to all-pixel read according to the present invention comprises a signal processor in a former stage for converting the video signal inputted from the image sensor into a digital image data, a temporary memory for horizontal flip for temporarily memorizing the digital image data outputted from the signal processor in the former stage and outputting the memorized image data in such a manner that the image data is horizontally flipped on an image, a signal processor in a latter stage for signal-processing the digital image data outputted from the temporary memory for horizontal flip, and a clock generator for supplying a clock signal to the signal processor in the former stage and the temporary memory for horizontal flip and supplying a clock signal having a clock rate lower than that of the clock signal to the signal processor in the latter stage.

### BACKGROUND OF THE INVENTION

1. Field of the Invention

The present invention relates to a technology for reducing power consumption of a video signal processing circuit for executing predetermined processings to a video signal obtained by an image sensor and outputting the processed video signal.

2. Description of the Related Art

A conventional digital camera (digital still camera, digital video camera, camera-incorporated mobile telephone and the like) comprises an image sensor for obtaining an image of a photographic subject and a video signal processing circuit for executing predetermined processings to a video signal obtained through the image taking by the image sensor. The video signal processing circuit executes a preliminary processing and a YC processing. The video signal processing circuit executes all of these processings at a clock rate identical to that of the image sensor in order to process the video outputs from the image sensor sequentially obtained at the identical clock rate without any delay.

In order to execute the foregoing processings, the clock rate of the video signal processing circuit and the clock rate of the image sensor are equal to each other. However, a display processing in an image display device or an external display does not always require a clock rate as fast as that of the foregoing processings. Therefore, when the video signal is ready to be outputted after the predetermined processings are executed thereto in the video signal processing circuit, the clock rate is converted to such a level that allows the video signal to be processed in the image display device or the external display on the system at an output stage of the video signal processing circuit, and the video signal is outputted at the converted clock rate.

When a flip-horizontal processing is executed in the conventional video signal processing circuit, a flip-horizontal SRAM (Static Random Access Memory) for one line is generally provided between a preliminary processing unit and a YC processing unit. In the SRAM, a write address and a read address are reversed for each line so that an obtained image data can be horizontally flipped.

When a moving image is obtained in the conventional digital camera, pixels are read from the image sensor by means of pixel-thinning read or pixel-mixing read because it is time consuming to read and process all of the pixels, which results in a failure to satisfy a frame rate necessary for the moving image. The pixel-thinning read is a method for thinning and reading the pixels, wherein the pixels are generally thinned for each line. No. H11-234688 of the Publication of the Unexamined Japanese Patent Applications recites an example of the technology for thinning and reading the pixels. The pixel-mixing read is a method for mixing and reading the pixels, an example of which is recited in detail in No. 2003-230054 of the Publication of the Unexamined Japanese Patent Applications.

In the above Japanese Patent Literatures, the pixel-thinning reading mode or the pixel-mixing reading mode is selectively executed so that the number of the pixels to be processed is reduced, and the frame rate necessary for the moving image can be assured.

As the image sensor is designed to include a larger number of pixels, the clock rate in reading the video signal from the image sensor is increased. In accordance with the increased speed of the clock rate, the clock rate supplied to the video signal processing circuit also is also increased. However, the supply of the high-speed clock to any section not demanding the high-speed clock results in unnecessary power consumption.

More specifically, in the pixel-tinning reading mode and the pixel-mixing reading mode, the horizontal pixels are thinned and read from the image sensor. Therefore, the number of the apparent pixels is at most ½ of the number of the effective pixels. In such a case, a horizontal blanking period is extended in comparison to the all-pixel reading mode. In the conventional technology, however, the circuit is operated at such a high-speed clock that is necessary for reading the pixels during the blanking period. Such a high-speed cock, which is unnecessary for the pixel-tinning reading mode and the pixel-mixing reading mode, only results in the unnecessary power consumption.

### SUMMARY OF THE INVENTION

Therefore, a main object of the present invention is to allow a suitable clock rate to be selected so that power consumption is reduced.

In order to achieve the foregoing object, a video signal processing circuit for processing a video signal inputted from an image sensor capable of reading pixels by means of pixel-thinning read or pixel-mixing read in addition to all-pixel read according to the present invention comprises:

a signal processor in a former stage for converting the video signal inputted from the image sensor into a digital image data;

a temporary memory for horizontal flip for temporarily memorizing the digital image data outputted from the signal processor in the former stage and outputting the memorized image data in such a manner that the image data is horizontally flipped on an image;

a signal processor in a latter stage for signal-processing the digital image data outputted from the temporary memory for horizontal flip; and

a clock generator for supplying a clock signal to the signal processor in the former stage and the temporary memory for horizontal flip and supplying a clock signal having a clock rate lower than that of the clock signal to the signal processor in the latter stage.

In the foregoing constitution, the image sensor may be adapted to be capable of both of the pixel-tinning read and the pixel-mixing read. A preferable example of the image sensor is an MOS sensor randomly accessible.

According to the foregoing constitution, the signal processor in the latter stage is driven by the clock signal having the clock rate lower than a normal level in the pixel-thinning read and the pixel-mixing read in which a horizontal blanking period is extended. As a result, power consumption is reduced. The conversion of the clock rate demands a temporary memory (line memory) for at least one horizontal cycle. When the temporary memory for horizontal flip is used also as the temporary memory, the power consumption can be reduced without increasing a memory area.

As a preferable mode of the foregoing constitution, the digital image data is written in the temporary memory for horizontal flip at the normal clock rate, the digital image data is read from the temporary memory for horizontal flip at a clock rate ½ of the normal clock rate, and a write address at which the digital image data is written in the temporary memory for horizontal flip and are ad address at which the digital image data is read from the temporary memory for horizontal flip are reversed for each line. Accordingly, the digital image data can be written and read with respect to the memory without any collision.

As a preferable mode of the foregoing constitution, the temporary memory for horizontal flip comprises:

a counter for generating a write allowance/non-allowance signal and a read allowance/non-allowance signal as a logic inversion thereof at the clock rate ½ of the normal clock rate in such a manner that the counter is reset by a horizontal synchronous signal and counts the clock signal having the normal clock rate;

an input-side flip-flop for temporarily retaining the digital image data inputted from the signal processor in the former stage in a synchronous state with respect to the clock signal having the normal clock rate;

a memory for horizontal flip which the digital image data from the input-side flip-flop is written in and read from in a state where write allowance/non-allowance and read allowance/non-allowance are alternately controlled in accordance with the write allowance/non-allowance signal and the read allowance/non-allowance signal;

an output-side flip-flop for temporarily retaining the digital image data read from the memory for horizontal flip; and

a selector for selecting the digital image data outputted from the output-side flip-flop in such a manner as being controlled synchronously with the write allowance/non-allowance signal and the read allowance/non-allowance signal.

According to the foregoing constitution, the temporary memory for horizontal flip operating at the normal clock rate is used to process the video signal at the normal clock rate in the writing operation and to process the video signal at the clock rate ½ of the normal clock rate in the reading operation. Thereby, the temporary memory for horizontal flip can be used also as the temporary memory for the conversion of the clock rate.

In the foregoing constitution, the input-side flip-flop is preferably two flip-flops serially connected to each other, and the output-side flip-flop is preferably three flip-flops serially connected to one another.

Further, a SRAM preferably constitutes the temporary memory for horizontal flip or the memory for horizontal flip.

According to the foregoing constitution, the blanking period of the pixel-thinning read or the pixel-mixing read is utilized to reduce the processing clock in and subsequent to the output of the temporary memory for horizontal flip. As a result, the power consumption in the entire circuit can be reduced without increasing the memory area. Further, the image can be horizontally flipped.

The video signal processing circuit according to the present invention is effective as the technology for reducing the power consumption in a camera system comprising the image sensor capable of the pixel-thinning reading mode and the pixel-mixing reading mode.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram illustrating a constitution of an imaging device according to a preferred embodiment of the present invention.

FIG. 2 is a block circuit diagram illustrating a detailed constitution of a SRAM according to the preferred embodiment.

FIG. 3 is a timing chart illustrating an operation of the SRAM at the time of a horizontal flip in an all-pixel reading mode according to the preferred embodiment.

FIG. 4 is a timing chart illustrating an operation of the SRAM at the time of the horizontal flip in a pixel-thinning reading mode or a pixel-mixing reading mode according to the preferred embodiment in a manner similar to a conventional technology.

FIG. 5 is a timing chart illustrating an operation of the SRAM at the time of the horizontal flip in a novel pixel-thinning reading mode or pixel-mixing reading mode according to the preferred embodiment.

FIG. 6 is a timing chart illustrating an operation of the SRAM when a writing operation is started according to the preferred embodiment.

FIG. 7 is a timing chart illustrating an operation of the SRAM when the writing operation is terminated according to the preferred embodiment.

### DETAILED DESCRIPTION OF PREFERRED EMBODIMENTS

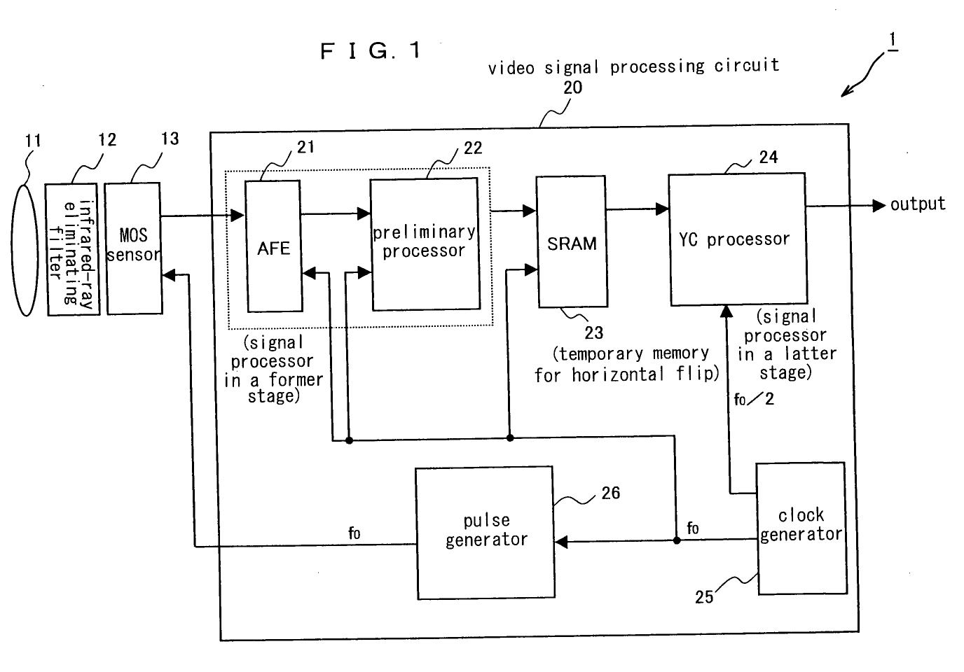

Hereinafter, preferred embodiments of a video signal processing circuit according to the present invention are described referring to the drawings. FIG. 1 is a block diagram illustrating a constitution of an imaging device according to a preferred embodiment of the present invention. The imaging device 1 according to the preferred embodiment comprises a lens 11, an infrared-ray eliminating filter 12, an MOS sensor 13 and a video signal processing circuit 20. The video signal processing circuit 20 comprises an AFE (analog front end) 21, a preliminary processor 22, a SRAM (including a SRAM access controller) 23 as a temporary memory for horizontal flip, a YC processor 24, a clock generator 25, and a pulse generator 26. The MOS sensor 13 is randomly accessible and an image sensor capable of pixel-thinning read and pixel-mixing read. The AFE 21 and the preliminary processor 22 constitute a signal processor in a former stage, and the YC processor 24 constitutes a signal processor in a latter stage.

A visible light condensed by the lens 11 and transmitting through the infrared-ray eliminating filter 12 is image-formed on the MOS sensor 13. The MOS sensor 13 converts the condensed optical signal into an electrical signal and outputs the electrical signal as a video signal. The video signal outputted from the MOS sensor 13 is outputted to the video signal processing circuit 20.

An analog gain of the video signal inputted to the video signal processing circuit 20 is corrected by the AFE 21. The video signal whose analog gain is corrected undergoes digital conversion, acquisition of an OB (Optical Black) correction value, shading correction, digital gain correction and γ correction by the preliminary processor 22, and is written in the SRAM 23 as a digital image data. The SRAM 23 is a SRAM for one line generally provided for horizontal flip.

The processings described so far are based on a normal clock rate f₀ outputted from the clock generator 25 irrespective of if all-pixel read or pixel-thinning read/pixel-mixing read is adopted. However, processings hereafter will be based on the clock rate of f₀/2, which is ½ of the normal level, in the pixel-thinning reading mode/pixel-mixing reading mode. In the YC processor 24, color correction, brightness correction, contour emphasizing and the like are applied to the digital image data. The pulse generator 26 operates in synchronization with the other circuit blocks at the clock rate of f₀, and generates a pulse for driving the MOS sensor 13. The clock generator 25 generates two different clock signals respectively having the clock rate of f₀ and f₀/2 and supplies the generated clock signals to the respective components.

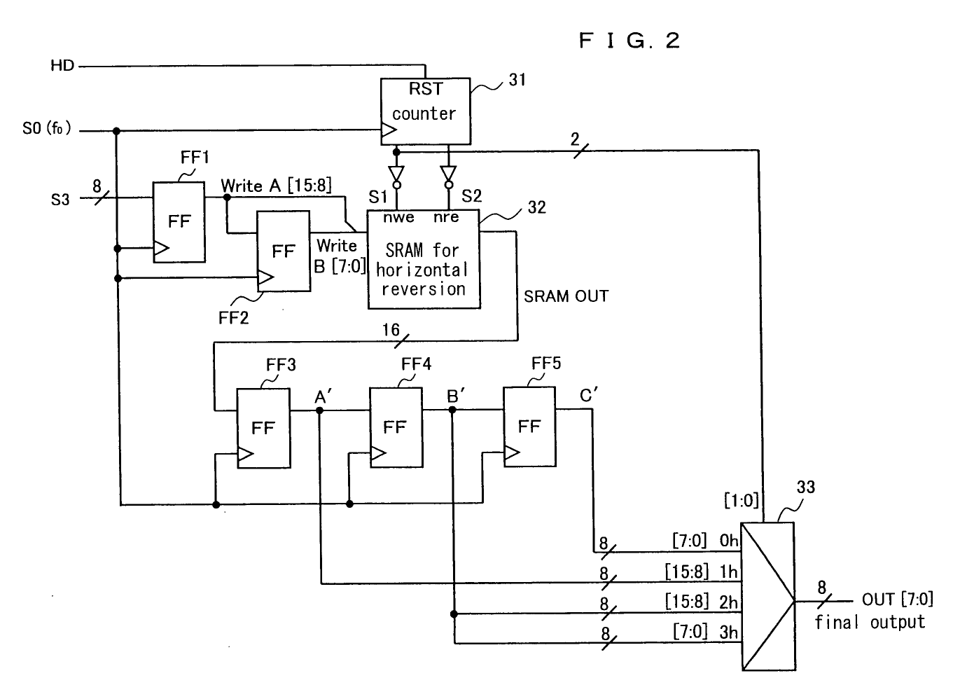

FIG. 2 is a block circuit diagram illustrating a detailed constitution of the SRAM 23 according to the preferred embodiment. The SRAM 23 comprises a counter 31, a SRAM 32, two flip-flops FF1 and FF2, three flip-flops FF3, FF4 and FF5, and a selector 33.

The counter 31 counts a clock signal S0 having the clock rate of f₀ in synchronization with a horizontal synchronous signal HD. The SRAM 32 functions to horizontally reverse a storage order in response to a write allowance/non-allowance signal (reverse write enable signal) S1 and a read allowance/non-allowance signal (reverse read enable signal) S2 as a logic inversion thereof from the counter 31. The flip-flops FF1 and FF2 are provided on an input side of the SRAM 32. The flip-flops FF1 and FF2 are serially connected to each other. The flip-flops FF3, FF4 and FF5 are provided on an output side of the SRAM 32. The flip-flops FF3, FF4 and FF5 are serially connected to one another. The selector 33 selects and outputs an output A′ of the flip-flop FF3, an output B′ of the flip-flop FF4, and an output C′ of the flip-flop FF5.

Next, an operation of the imaging device thus constituted is described below.

All-Pixel Read

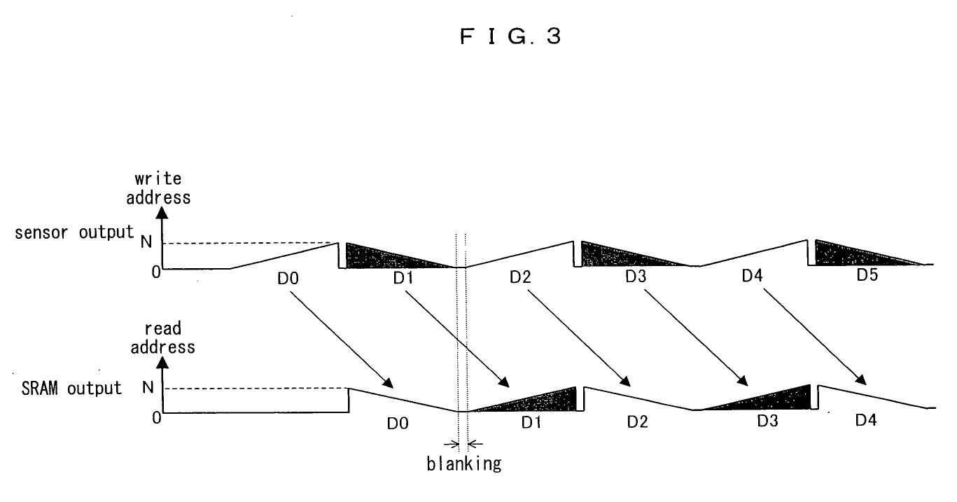

FIG. 3 is a timing chart illustrating an operation of the SRAM 23 at the time of the horizontal flip in the all-pixel reading mode in the conventionally manner. The clock rate is not converted in the all-pixel read. In an upper part of FIG. 3, a vertical axis denotes a write address of the SRAM 23, and a horizontal axis denotes time. In a lower part of FIG. 3, a vertical axis denotes a read address of the SRAM 23. Below is described an operation of the SRM 23 referring to FIG. 3.

A first pixel data in a data sequence D0 in a first line outputted from the MOS sensor 13 is written at an address number 0 in the SRAM 23 (SRAM 32 for horizontal flip). The pixel data is sequentially written up to an address number N (written in an ascending order) . When the data sequence D0 for one line has been written, the data sequence D0 is sequentially read from the SRAM 23 from the address number N through the address number 0 (read in a descending order), and outputted to the YC processor 24.

After the pixel data of the data sequence D0 written at the address number N is read, a first pixel data of a data sequence D1 in a second line is written at the address number N (written in the ascending order). Further, a second pixel data of the data sequence D1 in the second line is written at an address number N-1 after the pixel data of the data sequence D0 written at the address number N-1 is read (written in the descending order).

The foregoing steps are repeated up to the address number 0, so that the data sequence D0 is processed as a horizontally flipped data in comparison to an original arrangement of the pixel data. Such a risk that any wrong data may be written can be prevented because the data is sequentially written at the addresses which the pixels of the SRAM 23 are read from.

Next, the data sequence D1 is sequentially read in the ascending order from the address number 0 through the address number N, in parallel with which the data sequence D2 is sequentially written from the address number 0 through the address number N in ascending order. Thereafter, the data sequence D2 is sequentially read in the descending order from the address number N through the address number 0, in parallel with which a data sequence D3 is sequentially written in the descending order from the address number N through the address number 0.

The foregoing steps are repeated so that the data of one frame is all horizontally flipped on the image.

In FIG. 3, the number of the pixels to be processed is large because the pixels are read in the all-pixel reading mode, which shorten a blanking period. Assuming that one clock is necessary for writing and reading a pixel data, N clocks is necessary for processing the pixel data in one line.

In the Case of Adopting the Pixel-Thinning Read and the Pixel-Mixing Read at the Normal Clock Rate (f₀)

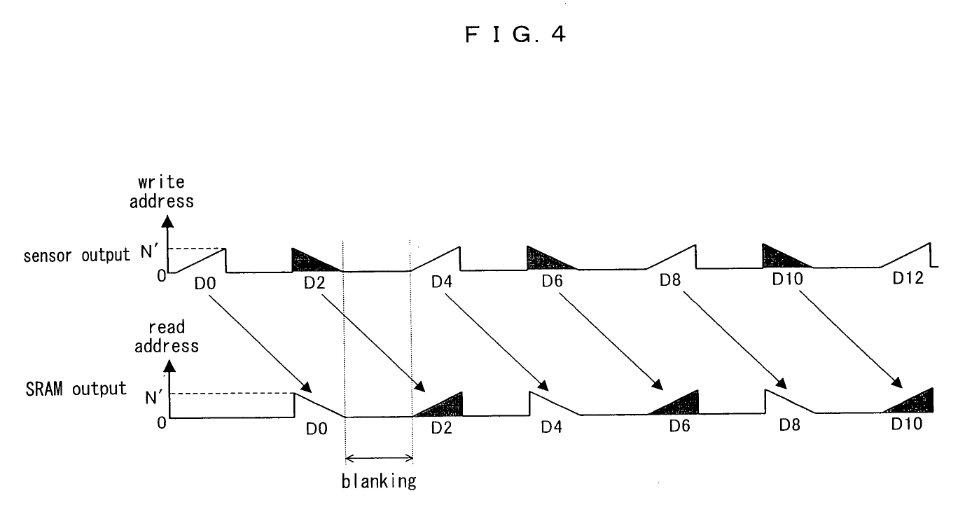

FIG. 4 is a timing chart illustrating an operation of the SRAM at the time of the horizontal flip in the pixel-thinning reading mode or pixel-mixing reading mode in the conventional manner. In FIG. 4, the pixels of one line are thinned for every two lines so that the data amount is halved, that is N′=N/2. The processing steps are similar to those shown in FIG. 3 and therefore not described here again.

As shown in FIG. 4, when the pixel-thinning read/pixel-mixing read is adopted, the number of the pixels in one line is reduced to N′(N′<N). As a result, the blanking period is extended. Therefore, the normal clock rate f₀ generates unnecessary power consumption in the reading operation.

The N′ clocks is necessary for processing the pixels in one line. More specifically, when the number of the pixels is reduced to the half in such a manner that the pixels are thinned or mixed, half the clock rate is sufficient for the processing to be executed in time.

In the Case of Adopting the Pixel-Thinning Read and the Pixel-Mixing Read at the ½ Clock Rate (f₀/2)

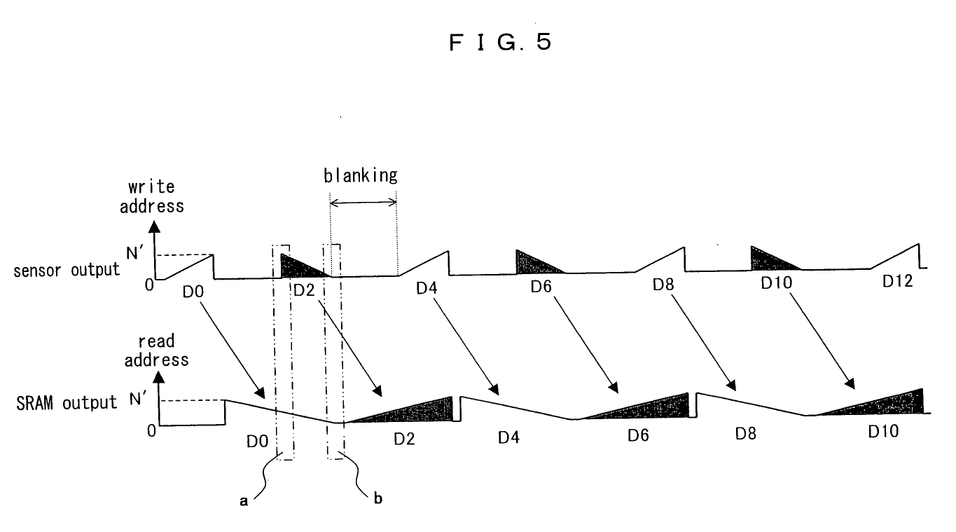

FIG. 5 is a timing chart illustrating an operation of the SRAM in the case of implementing the clock rate conversion and the horizontal flip in the pixel-thinning reading mode/pixel-mixing reading mode according to the preferred embodiment. In FIG. 5, the data is written in the SRAM 23 at the normal clock rate f₀ because it is necessary to synchronize with the clock rate f₀ in the output processing of the MOS sensor 13. In contrast to that, the data is read from the SRAM 23 at the clock rate f₀/2. In this manner, the clock rate for the processing in and after the SRAM 23, that is the clock rate for operating the YC processor 24, is reduced to ½, which results in the reduction of the power consumption. Further, the blanking period is extended because the number of the pixels to be processed is reduced. Therefore, when the data reading operation is commenced during the blanking period in the previous line, half the clock rate is sufficient for the processing to be executed in time. A timing of starting the reading operation is adjusted in order not to overwrite any pixel data which has not been read yet.

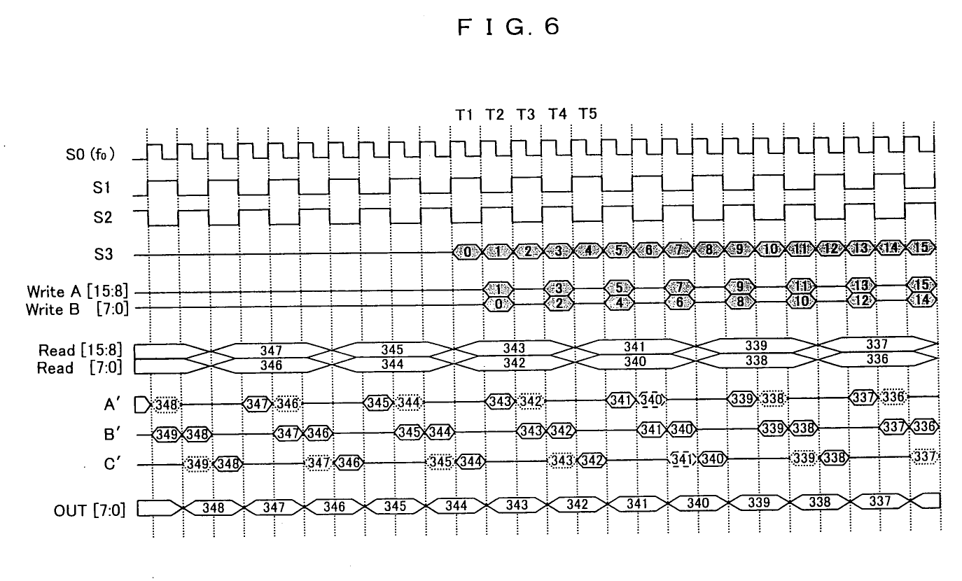

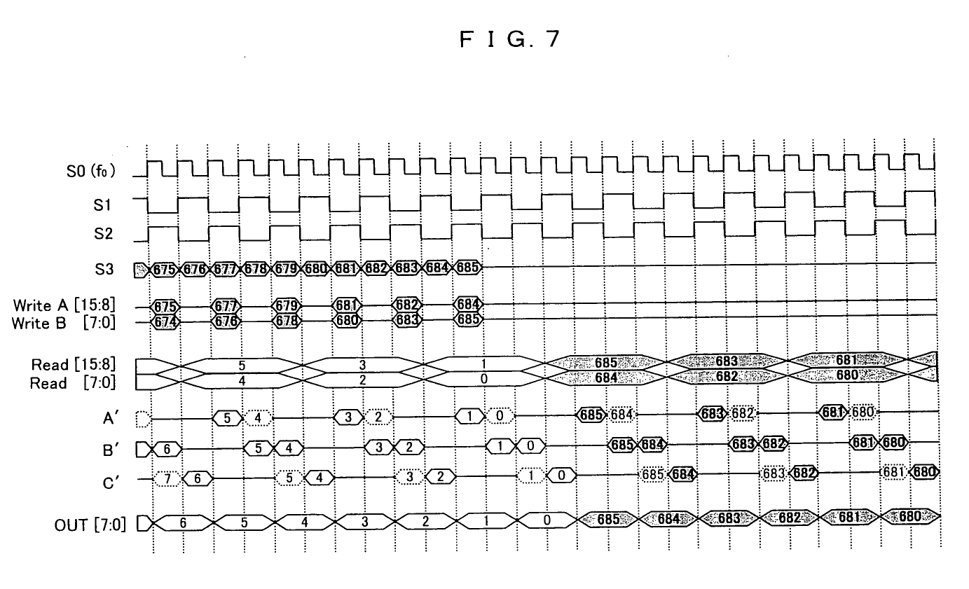

Referring to FIGS. 2, 6 and 7, a timing of starting the writing operation is described in detail. FIG. 6 is an enlarged view of a near field of a write-starting timing a shown in FIG. 5. FIG. 7 is an enlarged view of a near field of a write-ending timing. In FIGS. 6 and 7, S0 denotes the clock signal having the clock rate f₀. S1 denotes the write allowance/non-allowance signal instructing allowance/non-allowance of the writing operation with respect to the SRAM 32 for horizontal flip in the SRAM 23. S2 denotes the read allowance/non-allowance signal instructing allowance/non-allowance of the reading operation with respect to the SRAM 32 for horizontal flip. The write allowance/non-allowance signal S1 and the read allowance/non-allowance signal S2 are supplied from the counter 31 to the SRAM 32 for horizontal flip. The counter 31 counts the clock signal S0 having the clock rate f₀ in synchronization with the horizontal synchronous signal HD. The counter value is allocated to two bits. A low-order bit in the count value is used to generate the write allowance/non-allowance signal S1. Therefore, the write allowance/non-allowance signal S1 is HIGH when the count value is “Oₕ” (00) or “²h” (10). The low-order bit in the count value is also used to generate read allowance/non-allowance signal S2, however, a polarity of the read allowance/non-allowance signal S2 is reverse to that of the write allowance/non-allowance signal S1.

A sensor output pixel signal S3 shows the sequence number of the pixel data outputted from the MOS sensor 13. One pixel data is eight-bit data. Write A [15:8] denotes the pixel data written in high-order eight bits at one address of the SRAM 32 for horizontal flip. Write B [7:0] denotes the pixel data written in low-order eight bits at one address of the SRAM 32 for horizontal flip. A′, B′ and C′ respectively denote the pixel data outputted from the output-side flip-flops FF3, FF4 and FF5. The flip-flops FF3, FF4 and FF5 are provided between the read of the pixel data from the SRAM 32 for horizontal flip and the final output of the read data as described earlier. OUT [7:0] is the data finally outputted as a result of selecting the pixel data A′, B′ and C′ outputted from the output-side flip-flops FF3, FF4 and FF5 by the selector 33.

First, in a cycle T1, a first pixel 0 (eight bits) in the first line is outputted as the sensor output pixel signal S3, and retained in the input-side flip-flop FF1. At the time, the data is not written in a SRAM cell 34 the write allowance/non-allowance signal S1 is HIGH.

Next, in a cycle T2, a second pixel 1 in the first line is outputted as the sensor output pixel signal S3, and retained in the input-side flip-flop FF1. Further, the pixel 0 retained in the input-side flip-flop FF1 is retained in the input-side flip-flop FF2. Because the write allowance/non-allowance signal S1 is LOW, the pixel 0 retained in the input-side flip-flop FF1 passes through the input-side flip-flop FF2 and is stored in the low-order eight bits at the address number 0 of the SRAM cell 34 in the same cycle. The pixel 1 outputted from the MOS sensor 13 passes through the input-side flip-flop FF1 and is stored in the high-order eight bits.

In a similar manner, in a cycle T3, a pixel 2 is outputted as the sensor output pixel signal S3. In a cycle T4, the pixel 2 and a pixel 3 are stored at one address of the SRAM cell 34 as 16-bit data.

As described, the sensor output pixel signal S3 of eight bits outputted from the MOS sensor 13 is serially/parallelly converted by the input-side flip-flops FF1 and FF2 and written at one address of the SRAM cell 34 as a 16-bit signal.

In parallel with the writing operation with respect to the SRAM cell 34, the reading operation is executed to the previous line. First, in the cycle T1, a pixel 342 and a pixel 343 are retained in the output-side flip-flop FF3 as the 16-bit data because the read allowance/non-allowance signal S2 is LOW.

According to the clock signal S0 having the clock rate f₀, the sensor output pixel signal S3 is read and written in the SRAM cell 34 when the write allowance/non-allowance signal S1 is at “L” (Write A [15:8], Write B [7:0]). This processing is repeated in a cycle corresponding to ½ of the normal clock rate f₀, and the pixel data in one horizontal line in which the number of the pixels is thinned to at most ½ is written in the SRAM cell 34 for one line. In the reading operation with respect to the SRAM cell 34, the image data in the line before the horizontal line whose pixel data is being written in the SRAM cell 34 is read. At the time, the parallel/serial conversion is executed since the SRAM cell 34 is accessed at 16 bits. There ad data (Write A[15:8], Write B [7:0]) is selected by the selector 33 and outputted as the final output OUT [7:0]. At the time, the data output clock rate has been converted into the clock rate ½ of the SRAM write clock rate.

The write-ending timing b of the SRAM accessing timing is processed at a timing shown in FIG. 7. The processing executed at the time is similar to that of the write-staring timing a. When the sensor output pixel signal S3 has been written in the SRAM cell 34 and read from the SRAM cell 34, the signal is read first at the last address where the writing operation was executed in the order reverse to that of the writing operation. The pixel data A′, B′ and C′ (16-bit signal) read from the SRAM cell 34 are inputted to the selector 3 via the output-side flip-flops FF3, FF4 and FF5. In the selector 33, the pixel data A′, B′ and C′, whose high-order and low-order sides are selected, are outputted from the selector 33 as the output data OUT [7:0] of eight bits.

Next, a detailed operation of the SRAM access controlling section is described. The sensor output pixel signal S3 (eight bits) is serially/parallelly converted by the input-side flip-flops FF1 and FF2 into the video signal (16 bits). The video signal (16 bits) is written in the SRAM cell 34 by means of a 16-bit access processing when the write allowance/non-allowance signal S1 is at the “L”. The video signal (16 bits) written in the SRAM cell 34 is read by means of the 16-bit access processing when the read allowance/non-allowance signal S2 is at the “L”. The read video signal (16 bits) is converted into the video signal (eight bits) by the output-side flip-flops FF3, FF4 and FF5 and outputted from the output-side flip-flops FF3, FF4 and FF5 at the output clock rate ½ of the clock rate in the writing operation with respect the SRAM. The video signal (eight bits) outputted from the output-side flip-flop FF3 is the pixel data A′, the video signal (eight bits) outputted from the output-side flip-flop FF4 is the pixel data B′, and the video signal (eight bits) outputted from the output-side flip-flop FF5 is the pixel data C′.

The pixel data A′ is effective when value of the lower-order two bits of the write allowance/non-allowance signal S1 outputted from the counter 31 is “1 h”. The pixel data B′ is effective when the values of the lower-order two bits of the write allowance/non-allowance signal S1 is respectively “2 h and “3 h”. The pixel data C′ is effective when the value of the lower-order two bits of the write allowance/non-allowance signal S1 is “0 h”. As described, the three pixel data A′, B′ and C′ are selected by the selector 33 so that the final output OUT [7:0] is generated.

In the present preferred embodiment, the SRAM cell 34 for one line is provided so that the output clock rate of the SRAM cell 34 is reduced to ½ of the clock rate of the sensor output pixel signal S3 and the horizontal flip output processing is executed. In other words, the SRAM is commonly used as the SRAM necessary for converting the clock rate and the SRAM for horizontal flip, which prevents the SRAM area from increasing. The horizontal flip is not an indispensable processing in the present embodiment.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A video signal processing circuit for processing a video signal inputted from an image sensor capable of reading pixels by means of pixel-thinning read or pixel-mixing read in addition to all-pixel read comprising:
a signal processor in a former stage for converting the video signal inputted from the image sensor into a digital image data;
a temporary memory for horizontal flip for temporarily memorizing the digital image data outputted from the signal processor in the former stage and outputting the memorized image data in such a manner that the image data is horizontally flipped on an image;
a signal processor in a latter stage for signal-processing the digital image data outputted from the temporary memory for horizontal flip; and
a clock generator for supplying a clock signal to the signal processor in the former stage and the temporary memory for horizontal flip and supplying a clock signal having a clock rate lower than that of the clock signal to the signal processor in the latter stage.

2. The video signal processing circuit as claimed in claim 1, wherein
the digital image data is written in the temporary memory for horizontal flip at a normal clock rate,
the digital image data is read from the temporary memory for horizontal flip at a clock rate ½ of the normal clock rate, and
a write address at which the digital image data is written in the temporary memory for horizontal flip and a read address at which the digital image data is read from the temporary memory for horizontal flip are reversed for each line.

3. The video signal processing circuit as claimed in claim 1, wherein
the temporary memory for horizontal flip comprises:
a counter for generating a write allowance/non-allowance signal and a read allowance/non-allowance signal as a logic inversion thereof at a clock rate ½ of a normal clock rate in such a manner that the counter is reset by a horizontal synchronous signal and counts the clock signal having the normal clock rate;
an input-side flip-flop for temporarily retaining the digital image data inputted from the signal processor in the former stage in a synchronous state with respect to the clock signal having the normal clock rate;
a memory for horizontal flip which the digital image data from the input-side flip-flop is written in and read from in a state where write allowance/non-allowance and read allowance/non-allowance are alternately controlled in accordance with the write allowance/non-allowance signal and the read allowance/non-allowance signal;
an output-side flip-flop for temporarily retaining the digital image data read from the memory for horizontal flip; and
a selector for selecting the digital image data outputted from the output-side flip-flop in such a manner as being controlled synchronously with the write allowance/non-allowance signal and the read allowance/non-allowance signal.

4. The video signal processing circuit as claimed in claim 3, wherein
the input-side flip-flop is two flip-flops serially connected to each other, and
the output-side flip-flop is three flip-flops serially connected to one another.

5. The video signal processing circuit as claimed in claim 1, wherein
a SRAM constitutes the temporary memory for horizontal flip.

6. An imaging device comprising:
an image sensor capable of reading pixels by means of pixel-thinning read or pixel-mixing read in addition to all-pixel read; and
a video signal processing circuit for processing a video signal inputted from an image sensor, wherein
the video signal processing circuit comprises:
a signal processor in a former stage for converting the video signal inputted from the image sensor into a digital image data;
a temporary memory for horizontal flip for temporarily memorizing the digital image data outputted from the signal processor in the former stage and outputting the memorized image data in such a manner that the image data is horizontally flipped on an image;
a signal processor in a latter stage for signal-processing the digital image data outputted from the temporary memory for horizontal flip; and
a clock generator for supplying a clock signal to the signal processor in the former stage and the temporary memory for horizontal flip and supplying a clock signal having a clock rate lower than that of the clock signal to the signal processor in the latter stage.

7. The imaging device as claimed in claim 6, wherein the digital image data is written in the temporary memory for horizontal flip at a normal clock rate,
the digital image data is read from the temporary memory for horizontal flip at a clock rate ½ of the normal clock rate, and
a write address at which the digital image data is written in the temporary memory for horizontal flip and a read address at which the digital image data is read from the temporary memory for horizontal flip are reversed for each line.

8. The imaging device as claimed in claim 6, wherein the temporary memory for horizontal flip comprises:
a counter for generating a write allowance/non-allowance signal and a read allowance/non-allowance signal as a logic inversion thereof at a clock rate ½ of a normal clock rate in such a manner that the counter is reset by a horizontal synchronous signal and counts the clock signal having the normal clock rate;
an input-side flip-flop for temporarily retaining the digital image data inputted from the signal processor in the former stage in a synchronous state with respect to the clock signal having the normal clock rate;
a memory for horizontal flip which the digital image data from the input-side flip-flop is written in and read from in a state where write allowance/non-allowance and read allowance/non-allowance are alternately controlled in accordance with the write allowance/non-allowance signal and the read allowance/non-allowance signal;
an output-side flip-flop for temporarily retaining the digital image data read from the memory for horizontal- flip; and
a selector for selecting the digital image data outputted from the output-side flip-flop in such a manner as being controlled synchronously with the write allowance/non-allowance signal and the read allowance/non-allowance signal.

9. The imaging device as claimed in claim 8, wherein the input-side flip-flop is two flip-flops serially connected to each other, and
the output-side flip-flop is three flip-flops serially connected to one another.

10. The imaging device as claimed in claim 6, wherein
a SRAM constitutes the temporary memory for horizontal flip.
